(19) United States
(12) Patent Application Publication
(10) Pub. No.: US 2009/0120570 A1
(43) Pub. Date: May 14, 2009

(54) Method for Manufacturing Flooring with Thermoplastic Material

(76) Inventors: Bengt O. Johnard, Ljungskile (SE); Anders Linden, Askim (SE)

Correspondence Address: SCHWEGMAN, LUNDBERG & WOESSNER, P.A., P.O. BOX 2938, MINNEAPOLIS, MN, 55402, US

(21) Appl. No.: 11/795,458

(22) PCT Filed: Feb. 14, 2006
(86) PCT No.: PCT/SE06/00199

§ 371 Date: Jul. 8, 2008

(30) Foreign Application Priority Data
Feb. 15, 2005 (SE) 0500345-4

(51) Int. Cl. B32B 38/14

(52) U.S. Cl. 156/277

(57) ABSTRACT

A method for the production of a homogeneous, patterned flooring material. The method includes the deposition of thermoplastic particles in predetermined formations onto a sticky layer, so that the latter is covered in its entirety by a patterned first layer of particles in order to constitute a first layer of material. The method also includes the formation of an additional sticky layer, in conjunction with which an additional layer of particles with a pattern corresponding to that of the first layer is formed in order to constitute a further layer of material. These two layers are synchronized so that the patterns coincide in conjunction with the pressing operation and the layers of material form a homogeneously patterned flooring material. The two layers can either be formed on two separate surfaces, which are synchronized and joined together in a pressing arrangement, or they can be formed directly on top of one another by providing the first layer of material with a sticky layer and the subsequent deposition of thermoplastic particles in the sticky layer, so that an additional layer of particles with a corresponding pattern is deposited and becomes attached on top of the first layer of particles.

### TECHNICAL FIELD

The invention relates to a method for the production of a homogeneously patterned flooring.

### BACKGROUND ART

Homogeneous floor coverings are very practical in a public environment. They are normally manufactured from plasticized PVC, although other thermoplastic materials can be used.

A feature common to homogenous floorings is that they consist of a plastic material with an unchanged composition throughout its entire thickness, and that the decorative pattern is also transcurrent. In this way, it is possible to ensure that the appearance and characteristics remain unchanged, even if the flooring is exposed to wear over a long period.

The front side is often coated with a hardening coat of varnish during the manufacturing process. This ensures good cleaning ability not only on newly laid flooring, but also for a long period on floorings that have not been worn.

The total thickness of homogeneous floorings is normally 1.5-2.0 mm.

Homogeneous floorings are manufactured mainly by distributing different coloured plastic aggregates evenly over a web-shaped substrate. The material is then subjected to pressure and heat, so that the aggregates are smoothed out and fuse together at their boundary surfaces, yet retain their colour and size. The final result is a coherent floor covering, in which the decorative pattern consists of the different-coloured aggregates that are randomly distributed over the surface.

A disadvantage of existing technology is that only randomly distributed decorative patterns can be produced. The requirement for a decorative pattern to be present for the entire thickness of the floor covering precludes the use of traditional patterning technology, such as gravure and other methods of printing.

The object of the present invention is to make available homogeneous floorings with a selected patterning which harmonizes with the requirement for homogeneity, that is to say that the flooring material must be homogeneous with regard to both its composition and its decorative pattern through its entire thickness.

The achievement of a transcurrent, patterned surface layer on a homogenous flooring is previously disclosed through WO 2004/005045. The process is based on the principle of depositing small, coloured granules of a thermoplastic material of a specific size in a sticky mass on a web in a number of stages. In the first stage, granules of a single colour or a mixture of colours are laid out in a pattern via a stencil. The granules adhere to the sticky layer, and any surplus is removed. If necessary, the deposition process can be repeated with a number of stencils, each with its own mix of colours. In the final stage, an all-over layer of granules is laid over the entire web. Those surfaces of the web with the sticky layer that has already been coated with material that has been allowed to pass through patterned stencils are no longer sticky, as a consequence of which the all-over layer only attaches itself to surfaces that have not been coated with granules via a stencil. After further removal of loose, surplus granules, the surface of the web consists of a layer of essentially tightly packed granules which cover the sticky surface. A uniform mass distribution over the entire surface of the web is achieved due to the fact that the particles have a uniform and predetermined size.

The web is then subjected to heat and pressure so that the particles melt, are reformed to fill out the entire surface, and become attached to neighbouring particles as a result of fusion of the boundary surfaces. A coherent surface is obtained after cooling, which exhibits a pattern consisting of the different-coloured particles that were deposited at different times, and a depth of pattern that is determined by the size of the particles.

The above procedure constitutes an effective and relatively simple way of achieving a pattern extending over the depth. The system is subject to limitations, however, in conjunction with the manufacture of homogeneous floorings according to the previously indicated definitions. Homogeneous floorings must accordingly be capable of having a thickness of 2 mm. This thickness can in itself be achieved according to WO 2004/005045 by depositing particles on a release paper coated with an adhesive substance. The thickness of the finished pattern bears a specific relationship to the size of the granules. A pattern with a thickness of 2 mm requires granules with a diameter of approximately 3 mm. With such large granules, however, the pattern image is indistinct, and people are obliged to accept very unrefined patterns as a result.

A method for manufacturing homogeneous floorings with controlled patterns is described in U.S. Pat. No. 4,076,567. With the help of metal stencils, small aggregates of different colours are released and allowed to fall onto different areas of a substrate to a depth which, after pressing, gives the desired thickness. A disadvantage of this method is that the aggregates that are released and allowed to fall exhibit a tendency, instead of remaining on the areas onto which they are released, to spread over uncoated areas of the substrate. As in the previous method, poorly-defined colouring and poor sharpness of the contours are obtained. Also described here is a method in which different-coloured materials in powder form are deposited onto a substrate so as to produce a specific depth by the use of metal moulds.

Once all the colours have been deposited, the walls of the moulds are removed and the substrate with the powder mass is then subjected to heat and pressure, in conjunction with which the powder melts and forms a homogeneous, patterned web. This method of producing a patterned, homogeneous web is complex and involved. It is difficult to remove the pattern moulds during the process without forfeiting sharpness in the pattern.

The object of the present invention is to overcome these problems and to permit the manufacture of homogeneous, patterned floorings with a thickness of up to at least 2 mm and a pattern that is sharper than with previous methods.

### DISCLOSURE OF INVENTION

The invention relates to a method for producing a plastic-based, patterned flooring material including the formation of a first, sticky layer and the subsequent deposition of thermoplastic particles in the sticky layer, which particles consist of at least two separate kinds of particles or mixtures of particles, in conjunction with which the aforementioned particles are deposited in two or more stages in predetermined formations onto the sticky layer, so that the latter is covered in its entirety by a patterned first layer of particles in order to constitute a first layer of material. The method is characterized in that at least one additional sticky layer is formed, onto which particles are deposited to form a further layer of particles, with patterns corresponding to those of the first layer, in order to constitute a further layer of material, in conjunction with which the aforementioned further layer is synchronized with the first layer so that the patterns, when they are joined together, are matched to form a flooring material that is homogeneously patterned in a section perpendicular to the surface plane of the flooring material.

The expression “in the form of a sheet” is used below to describe the flooring material in certain cases. Material in the form of a sheet is used in this application to denote a thin material layer, which, for example, may consist of rectangular layers of material possessing the ability to be rolled up. The expression “in the form of a sheet” thus only denotes the form of the material in the sense that its thickness is small relative to the length and width of the material.

The layers are joined together preferably by causing the particles that are present in the layers to fuse together under pressure. Depending on the material characteristics of the particles, the temperature and pressure may be adapted to give good fusion, so that a homogeneous flooring is formed. This joining process is performed with advantage before the different layers have undergone thermal treatment or surface treatment in order to form a smooth web of material, so that the risk of a visible boundary layer occurring between the fused layers of material is minimized. Fusion may take place in a belt press, for example, in which the temperature and the pressure can be regulated. The pressure does not usually need to be particularly high if the temperature is accurately adapted to ensure that the flooring mass is suitably viscous or soft. It is also conceivable for the layers of material to be thermally treated before they are compressed in the belt press, so that the constituent particles in the layers of material exhibit a suitable temperature for them to be joined together when they arrive in the actual pressing arrangement.

The expression “particles or mixtures of particles of different kinds” denotes primarily that the particles have different colours or, in appropriate cases, that the mixtures of particles contain a different assortment of coloured particles. The particles can also differ in other respects, for example in their form or size, so that the compositions in the finished flooring material in the form of a sheet can be distinguished from one another.

According to one preferred form of the invention, the method is performed by producing the first layer of material and at least a further layer of material on separate surfaces. The two different layers will be constituted in this case by two separate webs of material, which are brought together and joined together to produce a flooring material in the form of a sheet. It is, of course, possible to do this for more than two layers, if required.

According to a further preferred embodiment of the invention, two layers of material are intended to be joined together by pressing them together with the sticky layers of the respective layers of material facing away from one another. An advantage of this embodiment is that the homogeneity of the finished product is not subjected to the risk of being spoiled by an embedded sticky layer. In a particularly advantageous variant of this embodiment, the first sticky layer is intended to consist of a surface-reinforcing layer, for example varnishes, and/or the second sticky layer is intended to consist of an adhesion-improving material, for example an acrylic compound. The flooring material in this case, after the layers of material have been joined together, will be homogeneous having regard for both its material and its pattern, and will be provided with a layer on its upper side which makes it wear-resistant and easily maintained, and with a layer on its underside which facilitates the attachment of the flooring material to the floor.

A further advantage of this embodiment is the ability to obtain thicker flooring materials with a higher resolution in the pattern because the granules can be in the same order of size as for a flooring material that is only half the thickness or, alternatively, the ability to achieve improved resolution for a given thickness because the granules can be made smaller when two layers of material are joined together.

It also lies within the idea of this embodiment to position one or several additional layers of material with their associated sticky layers between the outer layers of material with their specially executed surface coatings. Where appropriate, it is thus conceivable that more than two webs of material will come together and will be joined together at an increased temperature and pressure. The sticky layers in these interjacent layers of material are preferably thin and consist preferably of a material that is so adapted as not to interfere with the joining process at the boundary layer or the pattern.

The character of the sticky layer can vary depending on which thermoplastic material is used. In the case of a PVC flooring material, the particles will consist of a softened, dyed PVC material. The sticky layer in this case may consist of transparent PVC plastisol. In the course of the pressing and thermal treatment that follow the joining together of the various layers, the plastisol will be integrated with the PVC construction. It is advantageous, however, for the sticky layer on the wearing surface of the flooring, that is to say the surface that is intended to constitute the upper side of the flooring, to be constituted by a hardening varnish. Examples of such varnishes are thermosetting urethane varnishes. In the case of thermal pressing, the varnish will harden and, in so doing, will form a surface finish on the final product. This surface finish can be substituted in appropriate cases for the separate surface varnish, which is often applied to traditional homogeneous floorings, in order to improve the characteristics of the floor in respect of its maintenance. An acrylic dispersion can be used as an alternative to the PVC plastisol for the sticky layer that constitutes the rear side of the finished flooring. This provides the finished product with good adhesion to any flooring adhesives that may be present.

In the case of an olefin-based flooring material, the particles consist of mixtures of olefin-based copolymers. In this case, too, it is advantageous for the upper sticky layer, which is intended to constitute the wearing surface of the flooring material, to consist of a surface varnish of the same character as for the PVC construction. The lower sticky layer consists of a similar varnish to that which, in the final product, will facilitate adhesion of the flooring to the substrate. It is customary today, for the same reason, for olefin flooring to be varnished separately on the underside. It may be necessary in the case of olefin floors to activate the particles with a corona treatment in order to ensure adhesion to the sticky layers.

The interjacent, sticky layers can be in the form of transparent PVC plastisol in the case of PVC-based flooring, and in the form of a hardening varnish of the aforementioned kind in the case of olefin-based flooring. A further possible example of an interjacent sticky layer is for it to consist of a solvent or some other highly volatile substance. The use of a highly volatile substance is one way of preventing the sticky layer from remaining in the product and interfering with its homogeneity. This substance may be ethyl acetate, for example, which lends itself particularly well to PVC-based flooring. The highly volatile substance is deposited and makes the surface of the already deposited particle layer sticky. A further layer of particles is now deposited, after which any surplus highly volatile substance is allowed to evaporate before the final pressing operation, in the course of which additional highly volatile substance is able to evaporate.

The surface-reinforcing layer may consist of a thermosetting polyurethane varnish, for example, and the adhesion-improving layer may consist of an acrylic dispersion, for example. The quantity of sticky material must ensure that the particles adhere. This situation is normally achieved with an applied wet weight of 10-100 g/m², and preferably 20-60 g/m². The sticky layers can be applied by a number of different methods, such as spreading a fluid mass, spraying, application by the gravure printing technique, or by roller application. The substance used in these cases consists of some form of more or less viscous mass, for example a plastisol. A number of different compositions of plastisols are suitable, and examples of sticky plastisols that can be used are contained in WO 2004/005045. It is also possible to apply the sticky layer as a film, which is unrolled or laid onto a surface. The film can either be sticky by nature or can be made sticky by thermal treatment, for example. In order to achieve a positive effect when joining together the different layers of material, it is often desirable for at least one of the sticky layers not to have hardened before the layers are joined together. This is associated with the advantage that those particles that have adhered to the sticky layer are capable of displacement along the surface of the sticky layer and, by so doing, of adapting themselves and engaging with the particles on adjacent layers of material, so that the process of joining the layers proceeds more smoothly together with good mixing of the layers of material with an associated reduced risk of the formation of an undesired boundary layer.

According to yet another embodiment of the invention, at least two of the layers of material must be formed on the same surface by providing the thermoplastic particles, which constitute the first layer of material, with a sticky layer, onto which particles are deposited in order to form an additional layer of particles, with a pattern which corresponds to the first layer. This embodiment thus differs from the previous embodiment, in which the layers of material were formed on separate surfaces, in that the two layers of material are formed on the same web. In this case, therefore, it is necessary to have a sticky layer between the two layers of particles. It is also conceivable in this embodiment to deposit any desired number of additional sticky layers and particles on top of the first layers. If desired, the uppermost layer of particles, which has already adhered to a sticky layer, can be provided on top with a sticky layer consisting of a surface-reinforcing layer and/or an adhesion-improving material. In this case, the lowermost sticky layer can consist of a material which complements the uppermost layer so that the flooring material is provided on the different surfaces with layers that are respectively surface-reinforcing and adhesion-improving by their nature.

It is also possible to combine the different embodiments described here for the purpose of forming layers of material such that one and the same flooring material is formed by layers that have been formed on the one hand by the deposition of particles on separate surfaces which form discrete webs of material, and have been formed on the other hand by the deposition of particles in layers on top of one another on the same surface.

The particles that are used to form the layers of material can be of different sizes and shapes. According to one embodiment of the invention, the particles which form a layer of material must be of essentially identical size and identical shape. It is also conceivable, however, that they may be different in shape, for example if the particles consist of ground fragments. In this case, if desired, suitable size fractions can be obtained by sorting, for example by screening. In the event that the particles are identical in shape, they may possess many different shapes, for example cylindrical, oval or square. According to one preferred embodiment, the particles must be essentially spherical. The use of spherical particles and particles of identical size in the different layers of material is considered to be advantageous from the point of view that it is desirable to have closely-packed layers with a relatively uniform surface. The fact that the layers are closely packed means that the material is uniformly distributed over the surface and that there is an associated reduced risk of unevennesses, which can give rise to undesired variations in thickness and inhomogeneities in the finished flooring material, being caused in conjunction with the pressing process. The size of the spherical particles depends on the number of layers in the finished product and on the quantity of the sticky mass. With two layers and a quantity of sticky mass of 50 g/m² for each layer, the particles should have a diameter of 1.2 mm in order to obtain a finished product that has a thickness of 2 mm. Depending, among other things, on the number of layers, the desired definition of the pattern and the desired thickness of the finished product, the diameter of the particles that are suitable for the method described here may vary preferably between 0.3 and 3 mm. A diameter of 0.5 to 1.5 mm is particularly preferable in a number of cases.

To the extent that it is considered important for the particles to be identical in size and identical in shape, micro granulation is an appropriate method for the production of granules. The granules can, of course, be produced by a process involving the mechanical comminution of a mass, although the size and shape of the individual particles will vary to a considerably greater extent in these cases. Even if the mechanically processed particles are screened or graded for size in some way, they will exhibit greater variations, in conjunction with processing by commonly encountered methods, than the particles produced by micro granulation. Micro granulation involves extruding the mass that is to constitute the base for the flooring material through a nozzle with fine holes of the desired size. A knife at the perforated nozzle cuts off the extruded strings, which are hot and formable, into appropriate lengths, and the particles adopt a spherical form before cooling, through the effect of surface tension, so that these cut pieces are formed into a spherical granulate.

When choosing particles, they can be selected so that the different layers have different kinds of particles that are formed so that they engage closely with one another. It is conceivable, for example, in the case in which the flooring material consists of three layers of material comprising particles that are to be joined together, that the particles of the middle layer are smaller than the particles in the outer layers, so that the layers are readily able to engage with one another.

When choosing the size of particles, consideration is given to the desired thickness of the flooring, the requirement for a clearly defined pattern and the number of layers of particles to be included in the flooring. Small particles are desirable for a clearly defined pattern, although this requires more layers of particles in order to achieve the desired flooring thickness. It is true, however, that, the greater the desired number of layers, the larger and more expensive is the equipment necessary for manufacturing the flooring material.

The particles can be made from a number of different materials, although it is important that they possess thermoplastic characteristics such that they are capable of fusing in conjunction with heating and, in this way, of being joined together with neighbouring particles in the same and adjacent layers to form a homogeneous flooring material in the form of a sheet. An appropriate choice of material for the particles is PVC or polyolefins, for example. In both cases, it is important for the same type of recipes for the material and the material mixtures that are used for traditional flooring of this kind to be practicable. For PVC flooring, a typical composition may be as follows: 100 parts PVC, 20 parts plasticizer, 3 parts stabilizers, 40 parts filler and 3 parts pigment. This is only one example, and the choice of material is not considered to extend significantly beyond the requirement that it must be thermoplastic in nature in order to be able to fuse together and, in other respects, must include characteristics which make it suitable for use in flooring.

According to one embodiment of the invention, deposition of the particles takes place using a stencil process, in which particles or mixtures of particles of one or more different kinds are deposited in defined formations onto the sticky surface, leaving some areas uncoated, and particles or mixtures of particles of a kind which differs from any of the particles or mixtures or particles that were deposited in the stencil process are scattered over the sticky surface already provided with particle formations, in conjunction with which the scattered particles adhere to the aforementioned uncoated areas.

The embodiments described above provide examples of how the invention can be utilized. One particular advantage of the invention is that it permits the manufacture of homogeneous flooring with controlled patterning. Homogeneous flooring is conventionally described as being products consisting of one or more layers having the same composition and pattern through their entire thickness. In those cases in which the flooring is produced by the synchronized joining together of two layers of material with the same patterning, with their respective sticky layers facing away from one another, the flooring will be homogeneous all the way through. In those cases in which the flooring is produced by joining together several layers and a sticky layer is placed between the layers, its composition in a section through the flooring will be seen to vary slightly. It is nevertheless important for this sticky layer to be thin and to represent only a fraction of the mass that is constituted by the particles, which provide the bulk material for the flooring, and a construction of this kind can also be regarded as constituting a homogeneous flooring.

### BRIEF DESCRIPTION OF DRAWINGS

FIG. 1 illustrates schematically an arrangement for the manufacture of a homogeneous flooring with a controlled pattern according to one embodiment of the invention.

FIG. 2 illustrates a part of a flooring manufacturing arrangement, in which two webs of material meet at the entrance to a double belt press.

### MODE(S) FOR CARRYING OUT THE INVENTION

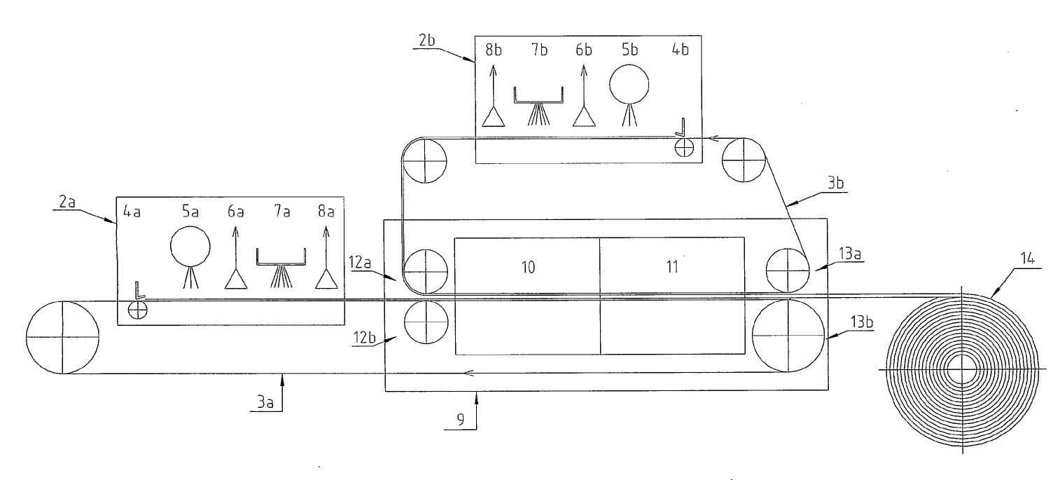

A preferred embodiment of the invention is described in FIG. 1. The flooring manufacturing arrangement 1 consists of two mat producing units 2a, b, which are identical from the point of view of their function. Each of the mat producing units is situated adjacent to its own conveyor belt 3a, b. According to the Figure, these mat producing units 2a, b include an applicator 4a, b for the application of a sticky mass to form a stick layer on the conveyor belt 3a, b. The mat producing units 2a, b also include a patterning unit 5a, b for the deposition or application of particles or granules in a controlled pattern, a first suction arrangement 6a, b for the removal of surplus granules deposited at the patterning units 5a, b, a filling unit 7a, b, which lays out or releases particles onto the uncoated areas of the sticky layer, and a second suction arrangement 8a, b for the removal of surplus granules by suction.

Both of the webs of material on the belts 3a, b are brought together in a double belt press 9. The double belt press comprises a joining zone 10, in which both of the webs of material fuse together under controlled pressure and heat, and a cooling zone 11. The double belt press 9 is provided at its entrance with a first pair of rollers 12a, b and is provided at its outlet with a second pair of rollers 13a, b. In the cooling zone 11, the flooring material that has now been formed is cooled to a suitable temperature to enable it to be rolled up at a rolling station 14. With regard to parameters such as the temperature and pressure in the joining zone 10, these are above all dependent on the material. If the temperature is so high that the granules have fused together for the most part, joining can take place at a relatively low pressure. The fact that the granules are properly fused will also reduce the risk of the formation of any kind of boundary layer between the joined webs of material.

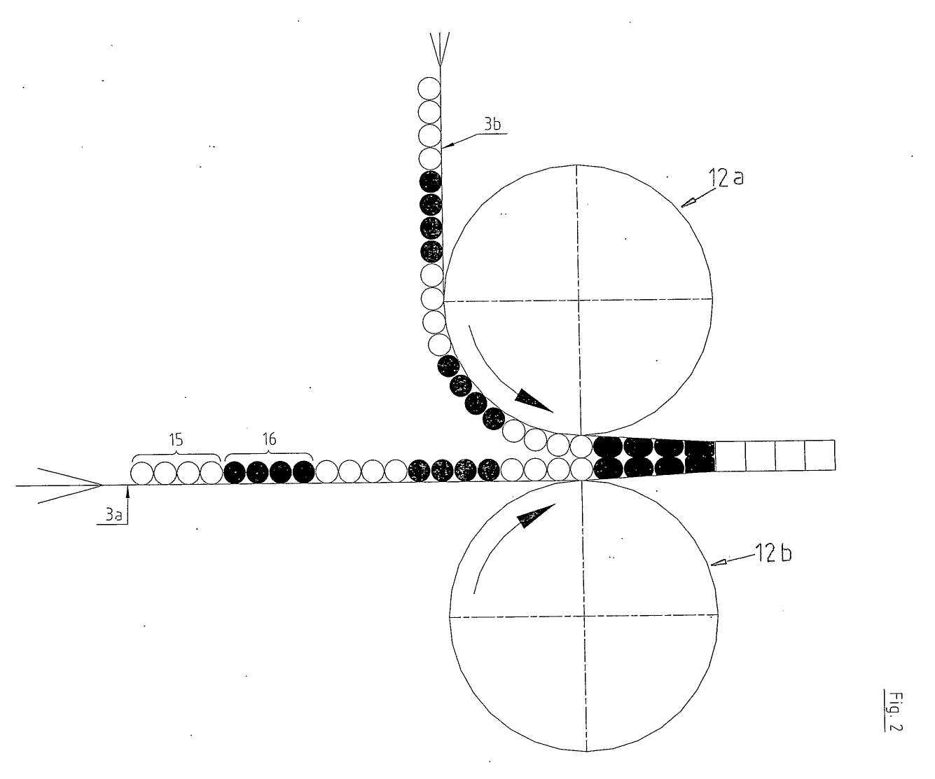

It is important for the invention that the webs to be joined together in the double belt press are properly synchronized. FIG. 2 illustrates an enlarged view of a section along the direction of travel of the conveyor belts 3a, b at the rollers 12a, b at the entrance to the double belt press. This illustrates how two material webs with a first kind of granules 15 and a second kind of granules 16 are synchronized with one another. The material webs are thus adapted in such a way that they produce a uniform pattern in a cross section through the finished flooring material. It can be an advantage in conjunction with the joining process if at least one of the sticky layers has not hardened, so that the granules are able to move in relation to one another.

The patterning as such is described relatively superficially here. Reference is made to WO 2004/005045 for a more detailed description of how a patterning unit may appear, and different variants of these. It is obvious to a person skilled in the art that considerable opportunities exist to vary the patterning within the scope of the invention. It is conceivable, for example, to include additional patterning units in the mat producing unit, so that more complex patterns can be formed using a greater number of different colours.

Although the patterning described in WO 2004/005045 constitutes an advantageous embodiment, it is obvious that it is possible to use other methods for patterned layers of material that are laminated together.

According to yet another embodiment, not illustrated here, it is possible to position two identical mat producing units one after the other on the same conveyor belt. By synchronizing these, two identical layers will thus be laid one on top of the other on the same belt. It is then possible to cause the flooring material produced in this way to be conveyed directly for hardening and pressing in order to complete the flooring material. It is also possible to cause the web of material, which has been produced with double layers, to be brought together with an additional web in a similar manner to that illustrated in FIG. 1, where the webs of material on the conveyor belts 3a, b are brought together ahead of the joining process.

The illustrative embodiments indicated above comprise only a few examples of how the invention can be utilized. There is thus considerable scope for a person skilled in the art to experiment within the context of the idea of invention, for example with different choices of material and relevant parameters for controlling the process.

1. Method for the production of a plastic-based, patterned flooring material including the formation of a first, sticky layer and the subsequent deposition of thermoplastic particles in the sticky layer, which particles consist of at least two separate kinds of particles or mixtures of particles, in conjunction with which the aforementioned particles are deposited in two or more stages in predetermined formations onto the sticky layer, so that the latter is covered in its entirety by a patterned first layer of particles in order to constitute a first layer of material, characterized in that at least one additional sticky layer is formed, onto which particles are deposited to form a further layer of particles, with patterns corresponding to those of the first layer, in order to constitute a further layer of material, in conjunction with which the aforementioned further layer is synchronized with the first layer so that the patterns coincide in conjunction with the pressing together of the layers of material to form a flooring material that is homogeneously patterned in a section perpendicular to the surface plane of the flooring material.

2. Method according to claim 1, characterized in that the first layer of material and at least one additional layer of material are formed on separate surfaces.

3. Method according to claim 2, characterized in that both the layers of material are joined together by being pressed together with the respective sticky layers of the layers of material facing away from one another.

4. Method according to claim 3, characterized in that the first sticky layer consists of a surface-reinforced layer and/or in that the second sticky layer consists of an adhesion-improving material.

5. Method according to claim 4, characterized in that the surface-reinforcing layer consists of polyurethane varnish.

6. Method according to claim 4, characterized in that the adhesion-improving layer consists of an acrylic dispersion.

7. Method according to claim 4, wherein the sticky layer consists of a fluid plastisol that is spread out, sprayed, applied by the gravure printing technique, by roller application, or as a film which is laid onto a surface.

8. Method according to claim 4, wherein at least one of the sticky layers has not hardened before joining together of the layers takes place.

9. Method according to claim 1, wherein at least two of the layers of material are formed on the same surface by the process of providing the thermoplastic particles, which constitute the first layer of material, with a sticky layer, onto which particles are deposited to form a further layer of particles, with a pattern corresponding to that of the first layer.

10. Method according to claim 1, wherein the particles are essentially of identical size and shape.

11. Method according to claim 10, characterized in that the particles are essentially spherical.

12. Method according to claim 11, characterized in that the particles exhibit a diameter between 0.3 and 3 mm.

13. Method according to claim 12, the particles consist mainly of one of polyolefin or PVC.

14. Method according to claim 1, wherein the deposition of the particles takes place in a stencil process, in which particles or mixtures of particles of one or more different kinds are deposited in specific formations on the sticky layer, leaving uncoated parts bare, and in that particles or mixtures of particles of a kind which differs from one or other of the particles or mixtures of particles that have been deposited by the stencil process, are scattered over the sticky surface provided with particle formations, in conjunction with which the scattered particles become attached to the aforementioned uncoated parts.

15. Method according to claim 11, wherein the particles exhibit a diameter between 0.5 and 1.5 mm.
